(19) United States
(12) Patent Application Publication
(10) Pub. No.: US 2026/0028215 A1
(43) Pub. Date: Jan. 29, 2026

(54) TELEHANDLER

(71) Applicant: DIECI S.R.L., Montecchio Emilia (RE) (IT)

(72) Inventors: Enrico OGNIBENE, Vezzano Sul Crostolo (RE) (IT); Gabriele MINARDI, Castelnovo Di Sotto (RE) (IT)

(21) Appl. No.: 19/024,969

(22) Filed: Jan. 16, 2025

(30) Foreign Application Priority Data
Jan. 30, 2024 (IT) 102024000001794

(51) Int. Cl. B66F 17/00; B66F 9/065; B66F 9/075

(52) U.S. Cl. CPC B66F 17/003; B66F 9/065; B66F 9/0755

(57) ABSTRACT

A telehandler including at least one base frame, provided with ground support wheels and stabilisers, at least one telescopic lifting arm articulated to said base frame, at least one piece of work equipment supported by the lifting arm, and an electronic control unit configured to determine, by sensors, one or more position parameters indicative of a current operating position of the telehandler from among the possible operating positions of the telehandler, calculate a maximum load that can be lifted by the equipment in the current operating position, and activate a safety procedure, if the equipment in the current operating position is subjected to a load that exceeds the maximum load that can be lifted.

### TECHNICAL FIELD

The present invention relates to a telehandler (i.e. a boom lift), preferably but not limited to a rotary telehandler.

### PRIOR ART

As is well known, known telehandlers have a set of sensors that detect the current working configuration of the telehandler, such as the elongation of the lifting arm, the tilt thereof, the tilt of the rotating turret supporting the arm and cab, the position of the ground supports, whether defined by stabilisers and/or wheels, etc.

Furthermore, a discrete number of load tables/diagrams are uploaded into the telehandler control unit, which correlate the various maximum loads that can be lifted by the lifting arm, depending on the elongation of the lifting arm and tilt thereof from the ground, in determined discrete operating configurations, such as supported on tyres, supported on fully extended/lowered stabilisers that determine the maximum support base, and other determined operating configurations.

Furthermore, each table is repeated for each piece of equipment, such as forks, baskets, hooks, winches, etc., which can be carried at the free end of the lifting arm.

In fact, however, the telehandler is required to operate in conditions other than the predefined ones, for example with only partially extracted stabilisers or in lifting arm operating positions that are not those for which the maximum load value, predefined during calibration of the tables, is present.

In such circumstances, therefore, the control unit is configured to derive the maximum load value that can be lifted by the lifting arm in a given operating configuration by (for example, linear) interpolation between two values taken from two different tables.

This known telehandler operability, however, has two main criticalities.

A first criticality is that this system is difficult to be maintained and updated, as it requires the insertion of new tables every time a new or different piece of equipment is allowed to be used (compared to those initially planned for such telehandler).

A second criticality is further due to the fact that the above-described operability, which provides determining the maximum load value for a given operating configuration by interpolation, actually limits the telehandler operability since the determination of the maximum load value for an “intermediate” operating configuration is not accurate and precise and, for safety issues, the safety factor applied in such “intermediate handling” zones may be overestimated, resulting in a limitation of the telehandler operability which may not be necessary.

A need felt in the industry is therefore to solve such criticalities of the known systems.

### DISCLOSURE OF THE INVENTION

An object of the present invention is to fulfil these and other needs of the prior art, within the framework of a simple, rational and cost-effective solution.

These objects are achieved by the features of the invention set forth in the independent claim. The dependent claims outline preferred and/or particularly advantageous aspects of the invention.

The invention, in particular, provides a telehandler comprising at least one base frame, provided with ground support wheels and stabilisers, at least one telescopic lifting arm articulated to said base frame, at least one piece of work equipment supported by said lifting arm (with the possibility of interchange between various pieces of equipment), and an electronic control unit configured to:
determine, by means of sensors, one or more position parameters indicative of a current operating position of the telehandler from among the possible operating positions of the telehandler;
calculate a maximum load that can be lifted by the equipment in the current operating position; and
activate a safety procedure, if the equipment in the current operating position is subjected to a load that exceeds the maximum load that can be lifted,
   wherein the maximum load that can be lifted by the equipment in the current operating position is calculated by the steps of:
determining an allowable load value for at least one criticality condition of the telehandler;
assigning to the maximum liftable load the allowable load value determined for said at least one criticality condition of the telehandler;
   wherein determining the allowable load value for each criticality condition of the telehandler is carried out by means of a computation procedure comprising:
determining a safety factor for said criticality condition;
determining, for said criticality condition, a maximum stress value in the current operating position, based on the position parameters and/or predefined structural parameters of the telehandler;
calculating, for said criticality condition, an allowable stress value in the current operating position as the product (or a function) of said safety factor by said maximum stress value in the current operating position; and
determining, for that criticality condition, the allowable load value as a function of that allowable stress value.

With such a solution, it is possible to obtain the above set-forth objects.

In particular, it is possible to reduce as much as possible the number of tables pre-calibrated during the machine design step to be uploaded onto the telehandler memory and, in addition, the system appears to be easily upgraded and adapted for any piece of equipment that may be added during the service life of the telehandler.

Furthermore, thanks to the solution set forth above, it is possible to increase the operability of the telehandler, which will be movable in any of the allowed operating positions with the minimum safety factor making it possible to use it safely.

As known, the telehandler is a multi-tool machine, meaning it allows for the interchange of work equipment attached to the end of the lifting arm, depending on the task to be performed.

Thanks to this solution, it is possible to make the telehandler a more “intelligent” machine, capable of autonomously determining its maximum load capacity given a known configuration, thereby eliminating the need for load charts and adapting the maximum load capacity based on the equipment mounted on the lifting arm.

Advantageously, the position parameters can be selected from the group consisting of at least: lifting arm tilt, lifting arm extension, lifting arm angle, stabiliser position.

According to one aspect of the invention, the safety factor may be a constant or a function of the position parameters in the telehandler current operating position and/or an indicative parameter of the equipment.

Thanks to this, the use of a predefined safety factor (either constant or variable according to a predefined function) makes it possible to increase the telehandler operability (even at positions that would have been inhibited by known control systems).

Advantageously, a first criticality condition can be an equilibrium criticality condition of the telehandler.

In such a case, when determining the allowable load value for this equilibrium criticality condition of the telehandler, the maximum stress value in the current operating position can be a maximum overturning moment, and the allowable stress value in the current operating position can be an allowable overturning moment, calculated as the product (or generally a function) of the safety factor and the maximum overturning moment in the current operating position.

Within this aspect, said maximum overturning moment can be equal to an allowable stabilising moment value in the current operating position, which can be calculated based on the position parameters and/or structural parameters of the telehandler. Further, the value of a maximum overturning moment in the current operating position is also determined based on one or more dynamic perturbation parameters, selected from the group consisting of: a parameter indicative of a predetermined air flow perturbing the equilibrium criticality condition of the telehandler, a predetermined acceleration of one or more movable components of the telehandler, an acceleration of the telehandler when movable on the wheels and a tilt of the base frame relative to the ground.

Thanks to such a solution, it is possible to take into account certain detrimental (recurring) configurations, such as a wind blowing from the worst side of the telehandler or other dynamic parameters due to the movement members regulating the actuation of the actuators and/or the propulsion of the telehandler).

According to a further aspect, the criticality condition can be at least a structural criticality condition of the telehandler.

In that case, in determining the allowable load value for said structural criticality condition of the telehandler, the maximum stress value at the current operating position may be a damaging/breaking maximum strain (e.g. a bending/torsional moment or force) of a telehandler component in the current operating position, and the allowable stress value in the current operating position may be an allowable strain of said telehandler component in the current operating position, calculated as the product (or in general a function) of the safety factor and the maximum stress value in the current operating position.

Further, in determining the allowable load value for said structural criticality condition of the telehandler, the electronic control unit is further configured to:
compare the calculated allowable load value for that structural criticality condition of the telehandler in the current operating position with a predetermined loading capacity; and
correct the allowable load value for said structural criticality condition of the telehandler in the telehandler current operating position by setting it equal to said loading capacity, if the calculated allowable load value is greater than the loading capacity.

Thanks to this, it is possible, when required, to operate a correction and/or a computational simplification for the electronic control unit to the safety benefit.

Advantageously, the loading capacity can be determined as the output of a pre-calibrated map obtained for a given reference piece of equipment and corrected with a conversion formula for the equipment currently connected to the lifting arm. Further, the maximum load that can be lifted by the equipment in the current operating position is calculated by the steps of:
repeating the computation procedure for a plurality of different criticality conditions of the telehandler, e.g. for at least one equilibrium criticality condition and at least one structural criticality condition, so as to obtain a corresponding plurality of allowable load values;
assigning to the maximum load that can be lifted by the equipment in the current operating position the lowest of said allowable load values.

Thanks to this, it is possible to execute an accurate and complete calculation, which takes into account and prevents all criticality conditions that can damage the telehandler.

Advantageously, the electronic control unit can be further configured to make available, on a telehandler display, a map or diagram of maximum loads that can be lifted by the equipment calculated for any possible operating position of the telehandler and any equipment supported by the lifting arm.

Thanks to this, it is possible to meet the legal requirements by giving the user visual feedback of the maximum loads and, at the same time, it is possible to obtain this diagram in a more accurate way than known systems and more versatile and adaptable to different telehandler use configurations.

Advantageously, the safety procedure provides to stop the telehandler and/or one or more of its movements (i.e. the movements of one or more of the components of the telehandler) or limit its operability or activate alarms or other warning procedures, so as to prevent the maximum load from being exceeded in the given current operating position.

Advantageously, furthermore, the equipment may comprise at least one memory unit readable via a dedicated telehandler sensor (e.g. placed on the lifting arm), wherein the memory unit contains or refers to design and structural information/data of the equipment itself, the electronic control unit being able to be configured to:
read the memory unit by means of the sensor;
retrieve design and structural information/data of the equipment currently connected to the lifting arm; and
calculate the maximum load that can be lifted by the equipment in the current operating position based on this design and structural information/data of the equipment.

In this regard, when the criticality condition is a structural equilibrium condition of the telehandler, in determining the allowable load value for said structural equilibrium condition of the telehandler, the maximum stress value in the current operating position is a maximum overturning moment, and the allowable stress value in the current operating position is an allowable overturning moment, calculated as the product of the safety factor and the maximum overturning moment in the current operating position, and wherein said maximum overturning moment is equal to an allowable stabilising moment value in the current operating position, which can be calculated based on the position parameters, the structural parameters of the telehandler, and the structural parameters of the equipment mounted on the lifting arm that have been retrieved from the memory unit of the equipment itself.

Furthermore, in this context, when the criticality condition is a structural criticality condition of the telehandler, in determining the allowable load value for said structural criticality condition of the telehandler, the maximum stress value in the current operating position is a maximum damaging/breaking strain of a component of the telehandler and/or the equipment in the current operating position, and the allowable stress value in the current operating position is an allowable strain of said component of the telehandler and/or the equipment in the current operating position, calculated as the product of the safety factor and the maximum strain value in the current operating position.

### BRIEF DESCRIPTION OF THE DRAWINGS

Further features and advantages of the invention will be more apparent after reading the following description provided by way of non-limiting example, with the aid of the accompanying drawings.

FIG. 1 is a (schematic) side view of a telehandler according to the invention.

FIG. 2 is a plan view from above of FIG. 1, with the turret in an reference angular position.

FIG. 3 is a plan view from above of FIG. 1, with the turret in an angular position angled relative to the reference angular position.

FIG. 4 is a diagram of a control system of the telehandler according to the invention.

FIG. 5 is a flow chart of a control executed by the telehandler control system according to the invention.

FIG. 6 is a schematic plan view of a telehandler according to the invention, which highlights the support area and the position of the centre of gravity of the telehandler and the point whereon the load is applied on the equipment thereof.

### BEST MODE TO IMPLEMENT THE INVENTION

With particular reference to these figures, a telehandler, preferably but not limited to a rotary telehandler, i.e. a vehicle for agricultural use, an earth-moving machine and/or an operating machine used in the construction field or other industry fields (and subject to specific reference legislation), for lifting loads, has been globally referred to as 10.

The telehandler 10 comprises a load-bearing frame 20 (or wagon), which is movable on (rubber) wheels 21, at least two of which are front wheels and/or two rear wheels, associated with a suitable powertrain (not shown as it is of a known type) to power them.

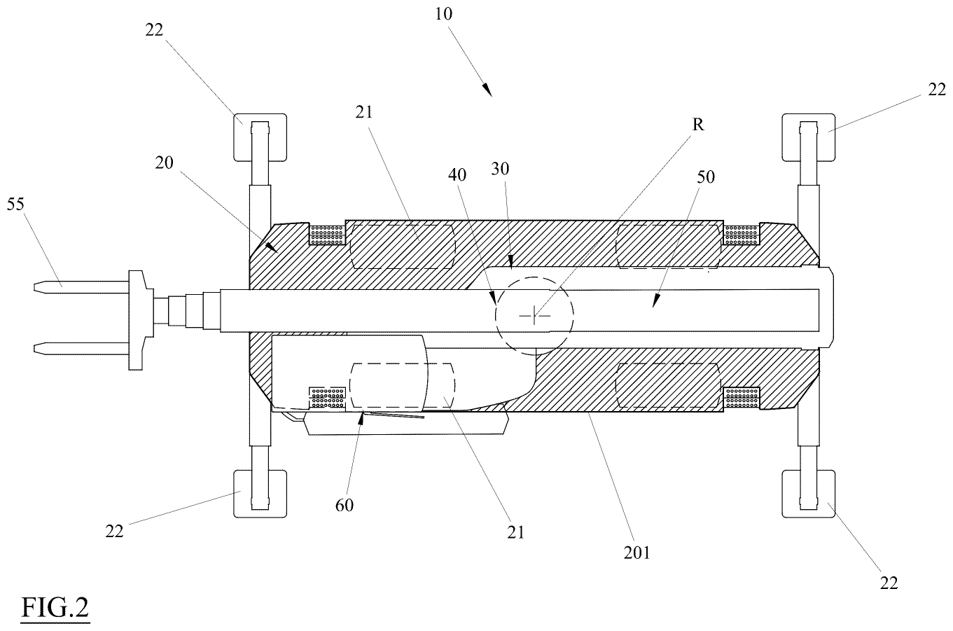

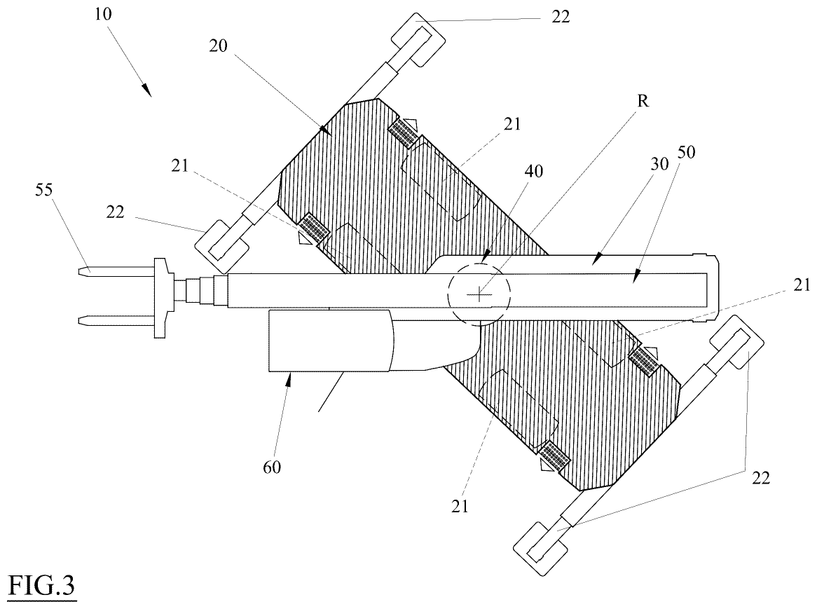

The load-bearing frame 20 could include ground support stabilisers 22 (see FIGS. 2 and 3) of which, for example, two front stabilisers and/or two rear stabilisers.

The stabilisers 22 are configured to stabilise the ground support of the telehandler 10, e.g. by enlarging the ground support area (i.e. the ground support polygon) with respect to the ground support area (or track) defined by the wheels 21 during determined working steps/conditions of the telehandler 10.

The stabilisers 22 are individually movably associated with the load-bearing frame 20 (e.g. tiltable and/or extendable), as known to the person skilled in the art, by means of specific actuators.

In particular, each stabiliser 22 is configured to be able to be switched, alternatively, between at least one working position (preferably several working positions, depending on the tilt and/or extension thereof), wherein the stabiliser 22 is supported on the ground (e.g. in addition to or in place of the ground support defined by one or more wheels 21), and at least one rest position, in which it is raised from the ground.

The telehandler 10 further comprises a turret 30 supported above the load-bearing frame 20.

The turret 30 is rotatably coupled to the load-bearing frame 20 around a (single) vertical rotation axis R (within the horizontal dimension of the load-bearing frame 20).

In the present discussion, vertical refers to either the absolute vertical or any direction orthogonal to the plane on which the front and rear wheels 21 and/or the stabilisers 22 of the telehandler 10 rest. Furthermore, “horizontal” refers herein to either the absolute horizontal or any plane parallel to the plane on which the front and the rear wheels 21 and/or the stabilisers 22 of the telehandler 10 rest.

A motorised (e.g. electrically) or actuated (e.g. hydraulically) fifth wheel 40 is located between the turret 30 and the load-bearing frame 20, which is configured to rotate the turret 30 with respect to the load-bearing frame 20 around the rotation axis R, e.g. by an angle (at least) equal to (or greater than) 360°.

The telehandler 10 further comprises a lifting arm 50 articulated with respect to the load-bearing frame 20.

Preferably, the lifting arm 50 is supported by the turret 30 (above it) and is, therefore, movable with it rotating about the rotation axis R.

The lifting arm 50 is preferably articulated or hinged (at its rear end) to the turret 30, e.g. above it, preferably at a rear section thereof.

The lifting arm 50 is hinged (at the top) to the turret 30 so that it can swing around a (single) horizontal swinging axis (i.e. orthogonal to the rotation axis R of the turret 30).

An actuator, e.g. hydraulic (preferably double-acting), is present between the turret 30 and the lifting arm 50 that is configured to actuate the swinging of the lifting arm 50 about the swinging axis (for lifting and/or lowering the lifting arm 50).

The lifting arm 50, for example, has an elongated shape along a longitudinal axis and therefore has a rear axial end thereof hinged to the (rear section of) the turret 30 and an opposite free front axial (distal) end.

The front axial end protrudes with respect to the load-bearing frame 20, i.e. the projection of the front axial end of the lifting arm 50, carried out along a (vertical) direction parallel to the rotation axis R of the turret 30, is (always) outside (the horizontal dimension of) the load-bearing frame 20.

The lifting arm 50 can therefore be raised/lowered by means of the rotation about the swinging axis.

The (extendible) lifting arm 50 is preferably of the telescopic type.

In particular, the lifting arm 50 has a plurality of sections or “extensions” that can be actuated between a contracted position and an extended position by means of at least one (double-acting) hydraulic actuator and one or more return elements, defined by one or more chains or other flexible transmission members.

The lifting arm 50 has, at its free front axial end, a connecting member, such as an equipment-holder plate, adapted to (releasably) connect to one or more interchangeable pieces of (work) equipment 55, such as buckets, forks (as in the case shown), pliers, cages, hooks, winches or other.

In particular, the lifting arm 50 is configured to support one piece of equipment 55 at a time among a plurality of (different and) interchangeable pieces of equipment 55.

Each piece of equipment 55 comprises a memory unit 550, e.g. readable via a specific reader (RFID and/or Bluetooth or similar), e.g. containing (or referring to) design and structural information/data of the equipment itself.

In practice, each piece of equipment 55, within its memory unit 550, contains all the structural information and parameters (for example, one or more of the following structural parameters selected from the group consisting of: equipment mass, equipment center of gravity, equipment surface exposed to wind, additional forces imposed by the equipment, maximum equipment load capacity, center of gravity of the load loaded on the equipment, surface exposed to wind of the load loaded on the equipment, maximum applicable accelerations in equipment movements, maximum applicable speeds in equipment movements, equipment dimensions, dimensions of the load loaded on the equipment, operating pressures, operating temperatures, usage cycles of the equipment, or combinations thereof) of the equipment 55 itself (wherein these parameters will be used for calculating the allowable maximum load, as described below).

The turret 30, for example, is oriented and stopped (through the fifth wheel 40), in the travel condition of the telehandler 10, in an angular reference position (see FIG. 2) wherein the longitudinal axis of the lifting arm 50 is parallel to the longitudinal (vertical) median (antero-posterior) plane of the load-bearing frame 20 (and is therefore centred on the load-bearing frame 20).

Furthermore, the turret 30 can be oriented/stopped, under stationary condition of the telehandler 10 (e.g. when stabilised), in any angular position (such as shown in FIG. 3), also different from the reference position, wherein the longitudinal axis of the lifting arm 50 (or its projection along the direction parallel to the rotation axis R) is angled/tilted with respect to the longitudinal (vertical) median (antero-posterior) plane of the load-bearing frame 20.

Further, the lifting arm 50 can be arranged/oriented (by swinging around the swinging axis) into a lowered reference (or minimum lift) position, where it is substantially horizontal (or proximal to the turret 30).

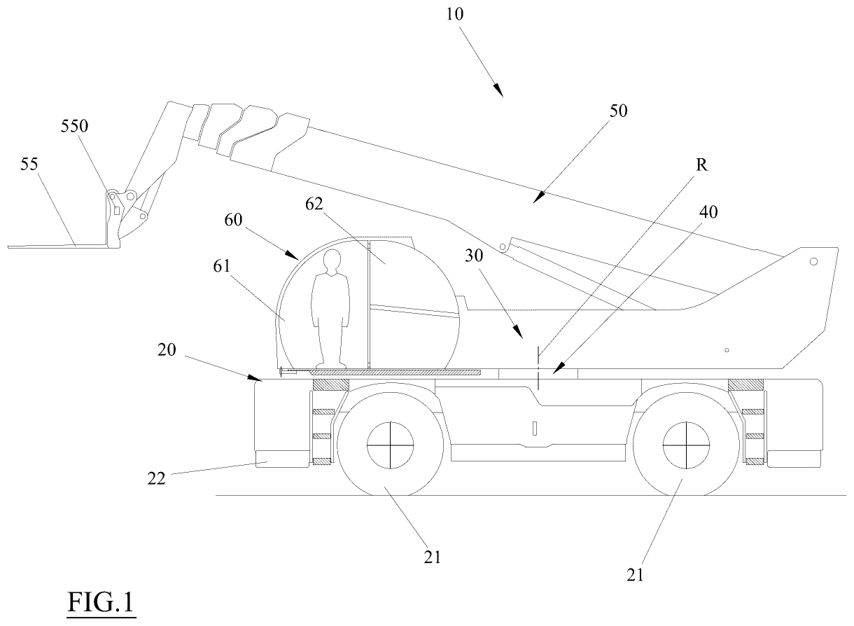

Furthermore, the lifting arm 50 can be arranged/oriented (by swinging around the swinging axis) in any raised position (see, for example, FIG. 1), up to a maximum lift position, wherein it is tilted with respect to the horizontal plane (or distal from the turret 30) by an angle preferably lower than 90°.

Further, the lifting arm 50 can be extended/shortened (by means of the actuator and chain linkages described above) to any position between a minimum elongation position (see FIGS. 1-3) and a maximum elongation position.

The telehandler 10 further comprises a (single) driver's cab 60, which is supported (on the top) and (rigidly) fixed to the turret 30, so the driver's cab 60 is movable with the turret 30 rotating about the rotation axis R.

The driver's cab 60 is arranged in a position that is eccentric to the rotation axis R of the turret 30, preferably the rotation axis R is outside the horizontal dimension of the driver's cab 60.

The driver's cab 60 is, for example, placed side by side (with respect to a flanking direction parallel to the swinging axis of the lifting arm 50) to a portion of the lifting arm 50 and is (all) arranged at one side of the lifting arm 50, preferably the left side thereof.

Inside the driver's cab 60 they are arranged a seat for housing the driver of the telehandler 10 and, at the front section, first (manual) commands which allow driving the telehandler 10 (i.e. manoeuvring and propelling it) and second commands (manual, e.g. separate from the first controls) which allow manoeuvring the turret 30 and/or the lifting arm 50.

Further, the telehandler 10 comprises, as known, a hydraulic circuit to control and command the movement of the various actuators (e.g. stabilisers 22 and/or lifting arm 50 and/or other tools).

The hydraulic circuit comprises at least one pump (e.g. actuated by the powertrain) and, preferably, a valve distributor configured to connect the pump to the various actuators.

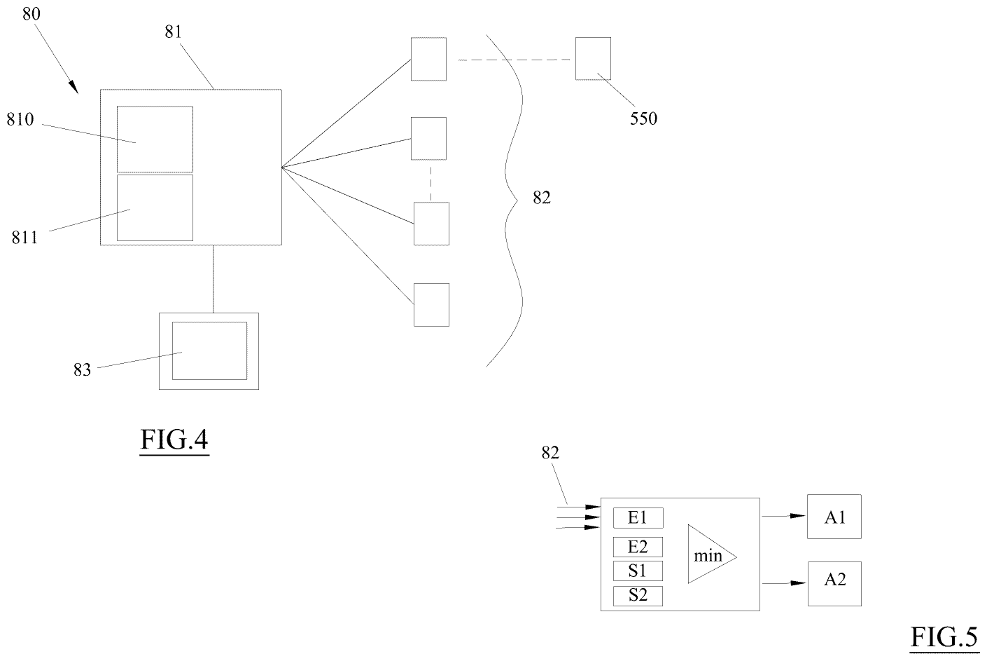

The telehandler 10 further comprises a control system 80 (schematically shown in FIG. 4), which is configured to control the operability of the machine itself.

In the embodiment being considered, the control system 80 comprises a controller module 81, a group of sensors 82 and, optionally, a user interface 83 (arranged within the cab 60), such as a display, through which various information (perceivable by the user, e.g. in the form of images, sounds or other) is made available to the user of the telehandler 10.

In particular, the controller module 81 comprises an electronic control unit 810 (for example, comprising at least one of a micro-controller, a microprocessor, an FPGA, an ASIC, etc.) and, optionally, a storage unit 811 (comprising, non-volatile memory elements and, preferably, volatile memory elements) interconnected with each other and adapted to process and store, respectively, information—for example, in binary format.

For instance, the storage unit 811 is a EEPROM unit.

The group of sensors 82 comprises, for example, an orientation sensor, e.g. mounted on the fifth wheel 40 or the load-bearing frame 20, configured to detect an orientation of the load-bearing frame 20 with respect to a zero position wherein the load-bearing frame 40 is substantially horizontal.

Orientation, for example, means an absolute orientation with respect to an absolute reference system defined by a horizontal plane (x, y) and a vertical axis (z).

The group of sensors 82 also comprises, for example, a first angle sensor, which is, for example, mounted on the fifth wheel 40 and is configured to detect, relative to the reference angular position, a relative angular position between a first ring and a second ring of the fifth wheel 40, detecting as such the angular position of the turret 30 with respect to the load-bearing frame 20.

For example, the first angle sensor is defined by an encoder of an electric motor of the fifth wheel 40.

Further, the group of sensors 82 may also comprise a second angle sensor, for example mounted on one of the base frame 20 and (the first section) of the lifting arm 50, which is configured to detect an angular position of the lifting arm 50 with respect to the turret 30 around the swinging axis with respect to the lowered position.

The group of sensors 82 then comprises an extension sensor, for example mounted on (one or more sections of) the lifting arm 50, which is configured to detect an extension of the lifting arm 60 relative to the minimum extension configuration thereof (taken as the zero position).

Further, the group of sensors 82 may comprise a third angle sensor, configured to detect a tilt of the equipment 55 (relative to the lifting arm or absolute).

Finally, the group of sensors 82 may comprise a load sensor, such as a load cell, mounted on one of (the free end of) the lifting arm 50 and the equipment 55, which is configured to measure the load burdening on the equipment 55.

Alternatively or additionally, the group of sensors 82 may comprise a pressure sensor of one or more of the actuators, (e.g. of the lifting arm 50 and/or stabilisers 22), which is configured to measure (indirectly) the load burdening on them (and thus on the lifting arm 50 and/or stabilisers 22).

The group of sensors 82 comprises a plurality of position/tilt sensors, one for each stabiliser 22, wherein each position/tilt sensor is configured to detect a position/tilt of the respective stabiliser.

Further, the group of sensors 82 may provide a plurality of pressure sensors, one for each stabiliser 22, each of which is placed at the support foot of the respective stabiliser 22.

Each pressure sensor is configured to detect a support pressure of the respective stabiliser, e.g. so as to define when it switches from a rest position to a working position.

The group of sensors 82 further comprises a reader or sensor configured to detect (the type and/or model of) the equipment 55 (actually) connected to the lifting arm 50.

The sensors of the group of sensors 82 globally are individually operatively connected to the controller module 81 and, preferably, to the electronic control unit 810 thereof.

Finally, if provided, the user interface 83 may comprise an input module for receiving instructions from an operator and an output module for providing the operator with information.

The control system 80, i.e. the electronic control unit 810, is also operatively connected to the powertrain and sensors thereof.

The control system 80, i.e. the electronic control unit 810, is also operatively connected individually to each actuator of the telehandler 10 and/or the pump and/or powertrain.

The telehandler 10 can be operated in a controlled manner, by means of the control system 80, as will be better described hereinafter.

In particular, the electronic control unit 810 is configured to determine (detect) one or more position parameters indicative of a current operating position of the telehandler 10 from among all possible operating positions of the telehandler 10 through the sensor group.

In particular, by way of non-limiting (or exhaustive) example, the electronic control unit 810 is configured to detect, by means of respective sensors and/or combination thereof and/or the user interface 83, at least one of the position parameters P selected from the following group (consisting of):
position of each stabiliser 22,
ground contact pressure of each stabiliser 22,
angular position of the fifth wheel 40 (i.e. of the turret 30 in relation to load-bearing frame 20);
angular position of the lifting arm 50;
extension of the lifting arm 50;
position/tilt of the equipment 55;
input from the user interface 83 or commands of the telehandler 10.

In practice, by detecting one or more of the aforesaid position parameters, the electronic control unit 810 is configured to determine the current operating position in which (each component) of the telehandler 10 is located.

Furthermore, the electronic control unit 810 is configured to have available a plurality of structural parameters of the telehandler 10, e.g. prefixed (for the given telehandler) and stored in the aforesaid storage unit 811.

The structural parameters, by way of non-limiting (or non-exhaustive) example, are selected from the following group (consisting of):
the materials from which the various components (such as the lifting arm 50, the various pieces of equipment 55, the turret 30, the stabilisers 22, the load-bearing frame 20, etc.) of the telehandler 10 are made;
or the coordinates of the centres of gravity of the various components (such as the lifting arm 50, the various pieces of equipment 55, the turret 30, the stabilisers 22, the load-bearing frame 20, etc.) of the telehandler 10;
design data, such as a maximum/critical stress, of the various components (such as the lifting arm 50, the various pieces of equipment 55, the turret 30, the stabilisers 22, the load-bearing frame 20, etc.) of the telehandler 10;
the own masses of each component of the telehandler 10.

Further, the electronic control unit 810 is configured to detect/measure, via one or more of the aforesaid sensors (e.g. the load sensor), a (current value of a) load burdening on the equipment 55.

Furthermore, the electronic control unit 810 (e.g., between the structural parameters) is configured to identify, via one or more sensors (e.g., the reader or sensor—RFID or Bluetooth or other—configured to detect the equipment 55 being connected to the lifting arm 50), which (type and/or model of) equipment 55 is connected to the lifting arm 50 (and, therefore, to have available all the structural and configuration design data thereof) and/or to retrieve unique design and structural information/data of the equipment 55 connected to the lifting arm 50.

In detail, the electronic control unit 810 is configured to retrieve design information/data, specifically the unique structural information/data of the equipment 55 which is connected to the lifting arm 50.

These structural (and design) information/data are stored (exclusively) in the memory unit 550 of the equipment 55 (and are not pre-stored in the storage unit 811 of the telehandler 10, in practice, this effectively prevents overloading the storage unit 811 itself).

In particular, the electronic control unit 810, in addition to identifying the type of equipment 55 currently mounted on the lifting arm 50, retrieves from it (i.e., from the memory unit 550 of the equipment 55) all the structural parameters of the equipment 55, that is the (only) structural parameters of the equipment 55 that is effectively mounted on the lifting arm 50, based on which it performs the calculation (of the permissible maximum load for each allowed operational configuration of that specific equipment 55).

Turning now to the operating steps of the control carried out by the electronic control unit 810, the electronic control unit 810, in general, is configured to identify a current operating position of the telehandler 10 by acquiring (e.g. measuring) one or more of the aforesaid position parameters, and to calculate a maximum load that can be lifted by the equipment 55 (fixed to the lifting arm 20) in the current operating position thus identified.

In particular, the electronic control unit 810 is configured to calculate the aforesaid maximum load taking into account at least one criticality condition, preferably at least a plurality of different criticality conditions of the telehandler 10, such as at least one equilibrium criticality condition and one structural criticality condition, which could jeopardise the (equilibrium or structural) stability of the telehandler 10 if the calculated maximum load is exceeded.

More specifically, the electronic control unit 810, for each criticality condition (e.g. for each of the two aforesaid criticality conditions) of the telehandler 10, is configured to execute a computation procedure comprising, in general:
determining a safety factor FS for said criticality condition;
determining, for said criticality condition, a maximum stress value Sₘₐₓ in the current operating position, based on the detected position parameters and/or the predefined structural parameters of the telehandler 10;
calculating, for said criticality condition, an allowable stress value Sₐₘₘ in the current operating position, as a function of said safety factor FS and of said maximum stress value Sₘₐₓ in the current operating position (preferably as the product of the safety factor FS by the maximum stress value Sₘₐₓ); and
determining, for said criticality condition, an allowable load value Qₐₘₘ as a function of said allowable stress value Sₐₘₘ.

Said safety factor FS (for each criticality condition) may be a constant, i.e. a predetermined constant value (equal or different for each criticality condition) or a function of the position parameters in the telehandler current operating position and/or a parameter indicative of the equipment 55, e.g. a linear function, FS=(k1×P)+k2, where k1 and k2 are predetermined constant parameters (and stored in the storage unit 811) and P is at least (a variable defined by) an aforesaid position parameter, for example the angular position of the lifting arm 50, the extension of the lifting arm 50 or a parameter defined by the equipment 55.

As anticipated and as will be better illustrated hereinafter and with reference to FIG. 5, the electronic control unit 810 is configured to repeat the computation procedure for a plurality of different criticality conditions of the telehandler 10, for example for at least one or more equilibrium criticality conditions and at least one or more structural criticality conditions, so as to obtain a corresponding plurality of allowable load values Q_{amm_1} . . . Q_{amm_n}.

### Calculation of the Allowable Load Value for Equilibrium Criticality Condition

For example, the electronic control unit 810 is configured to execute the computation procedure for a static equilibrium criticality condition (block E1 in FIG. 5).

More specifically, for this static equilibrium criticality condition of the telehandler 10, the electronic control unit 810 is configured to determine the maximum stress value Sₘₐₓ in the current operating position as a maximum static overturning moment MRₘₐₓ.

The electronic control unit 810 is configured to calculate said maximum static overturning moment MRₘₐₓ as that moment equal (and of opposite sign) to a value of the static stabilising moment MS in the current operating position, due to the masses of the various structural components of the telehandler 10, without taking into account any loads hanging from the equipment 55 (i.e. assuming that the equipment 50 is empty or unloaded).

This value of the static stabilising moment MS can therefore be calculated by the electronic control unit 810 based only on the position parameters and/or structural parameters of the telehandler 10.

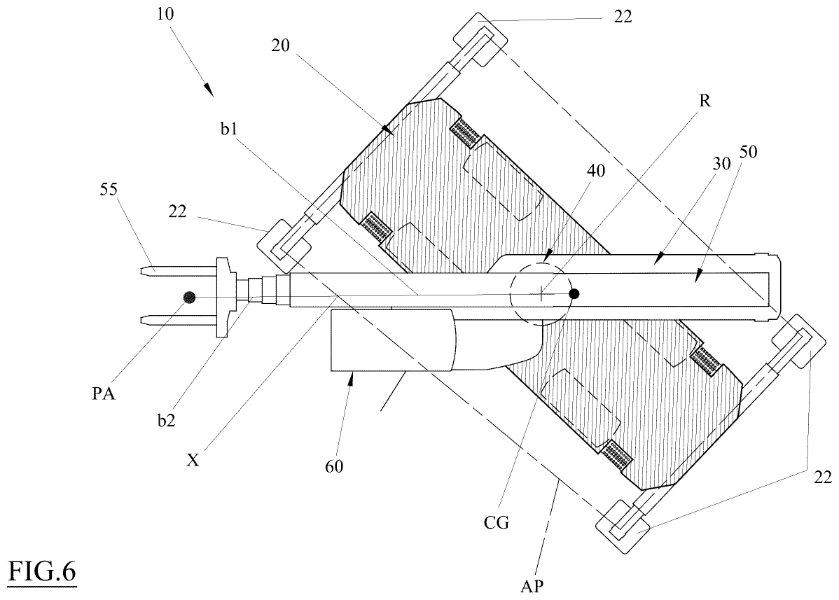

In particular, the electronic control unit 810, based on the current operating position, defines a ground support area AP (see FIG. 6) of the telehandler 10, as a polygon (e.g. a quadrilateral or a triangle) having at its vertices the most extreme support points of the telehandler 10, determined by the operating condition of the telehandler 10.

Further, the electronic control unit 810 is configured to calculate/determine, at the current operating position, a current total structural centre of gravity CG (i.e. its projection onto the plane containing the support area AP) of the telehandler 10, e.g. defined by the geometric sum of the centres of gravity of the individual structural components of the telehandler 10.

Furthermore, the electronic control unit 810 is configured to determine (based on position and structural parameters) the position of the equipment 55 in its current operating position and thus the current point of application PA of any load acting thereon.

The value of static stabilising moment MS is calculated as the product between a total structural mass (or weight force) of the telehandler 10 (i.e. the sum of the masses of the structural components composing it—i.e. without loads) applied at the (given) current structural centre of gravity CG of the telehandler 10 for a distance b1 between the current structural centre of gravity CG of the telehandler 10 and the point of intersection X between the perimeter of the support area AP and the straight line segment joining the structural centre of gravity CG and the current point of application PA of the load on the equipment 55.

Thus, the maximum static overturning moment MRₘₐₓ is calculated according to the following relation:

$$Static {MR}_{max} = MS = {Q}_{v} * b 1 ,$$

wherein:

Static MRmax is the maximum static overturning moment MRₘₐₓ, MS is the stabilising moment, and Qᵥ is the structural weight of telehandler 10 (as a whole and without loads) and b1 is the distance between the current structural centre of gravity CG of the telehandler 10 with the aforesaid point of intersection X.

Static MRₘₐₓ thus represents the theoretical maximum moment that a load associated with the equipment at the current point of application PA could generate, around the point of intersection X, without causing the telehandler 10 to overturn, as it is compensated by the static MS stabilising moment.

However, working under theoretical boundary conditions is generally not advisable in terms of safety.

Therefore, the electronic control unit 810 is further configured to calculate the allowable stress value Sₐₘₘ in the current operating position, for the static equilibrium criticality condition, as a static allowable overturning moment MRₐₘₘ resulting from the product of the safety factor FS and the maximum static overturning moment MRₘₐₓ in the current operating position.

The electronic control unit 810 is finally configured to calculate a (first) allowable load value Q_{amm_1}, for the static equilibrium criticality condition, based on the calculated allowable static overturning moment MRₐₘₘ, specifically as that load value Q_{amm_1} which, if applied on the equipment 55 at the current point of application PA, would generate an overturning moment, around the aforementioned point of intersection X, equal to the previously calculated allowable static overturning moment MRₐₘₘ.

Specifically, the allowable load value Q_{amm_1} (for the given current operating position and static equilibrium criticality condition) is therefore given by the calculated allowable static MRₐₘₘ overturning moment divided by b2, wherein b2 is a distance between the current point of application PA and the point of intersection X between the perimeter of the current support area AP intersected by the line segment passing through the centre of structural gravity CG and the current point of application PA.

Alternatively or in addition to the static equilibrium criticality condition, the electronic control unit 810 can be configured to execute the computation procedure for a (further or second) dynamic equilibrium criticality condition (see block E2 in FIG. 5).

Advantageously, for the dynamic equilibrium criticality condition, the electronic control unit 810 is configured to determine a (second) further allowable load value Q_{amm_2}, under dynamic equilibrium criticality conditions, i.e., capable of taking into account possible dynamic perturbation stresses, such as a predetermined air flow perturbing the equilibrium criticality condition of the telehandler, a predetermined acceleration of one or more movable components of the telehandler, an acceleration of the telehandler when moving on the wheels and a tilt of the base frame with respect to the ground or other.

In more detail, for this dynamic equilibrium criticality condition of the telehandler 10, the electronic control unit 810 is configured to determine the maximum stress value Sₘₐx at the current operating position as a maximum dynamic overturning moment MRₘₐₓ.

The electronic control unit 810 can be configured to calculate said maximum dynamic overturning moment MRₘₐₓ based on the maximum static overturning moment MRₘₐₓ (calculated as above) and a correction factor.

This correction factor, which may be greater or lower than 1 (i.e. which may increase or decrease the value of the maximum static overturning moment MRₘₐₓ), may be determined based on one or more dynamic perturbation parameters, selected from the group consisting of a parameter indicative of a predetermined airflow perturbing the equilibrium criticality condition of the telehandler, a predetermined acceleration of one or more movable components of the telehandler, an acceleration of the telehandler when moving on the wheels and a tilt of the base frame with respect to the ground and stored in 811.

For example, if the telehandler 10 was exposed to a direct wind in the sense of creating thereon a dynamic moment concordant with the static stabilising moment MS, the aforesaid correction factor could be greater than 1, whereas if it was exposed to a headwind, the correction factor could be lower than 1.

In practice, dynamic MRₘₐₓ represents the theoretical maximum moment that a load associated with the equipment at the current point of application PA could generate, around the point of intersection X, without causing the telehandler 10 to overturn, as it is compensated by the static stabilising moment MS increased or decreased by external dynamic stresses.

However, even in this case it is not advisable to work under theoretical boundary conditions.

Therefore, the electronic control unit 810 is further configured to calculate the allowable stress value Sₐₘₘ at the current operating position, for the critical dynamic equilibrium condition, as an allowable dynamic overturning moment MRₐₘₘ resulting from the product of the safety factor FS and the maximum dynamic overturning moment MRₘₐₓ in the current operating position.

The electronic control unit 810 is then configured to calculate the (second) allowable load value Q_{amm_2} based on said allowable dynamic overturning moment MRₐₘₘ, specifically as that load value Q_{amm_2} which, if applied on the equipment 55 at the current point of application PA, would generate an overturning moment, around said point of intersection X, equal to the previously calculated allowable dynamic overturning moment MRₐₘₘ.

Specifically, the (second) allowable load value Q_{amm_2} (in the given current operating position and dynamic equilibrium criticality condition) is given by the calculated dynamic allowable overturning moment MRₐₘₘ divided by b2, where b2 is the distance between the point of intersection X and the current point of application PA of the load on the equipment 55 of the telehandler 10.

Ultimately, the (second) allowable load value Q_{amm_2} for the dynamic equilibrium criticality condition can be calculated as the product of the allowable load value Q_{amm_1}, calculated for the static equilibrium criticality condition, and the corrective factor determined based on the above-mentioned external dynamic stresses.

### Calculation of the Allowable Load Value for a Structural Criticality Condition

For example, the electronic control unit 810 is configured to execute the computation procedure for one or more structural criticality conditions, i.e. criticality conditions that take into account the stresses acting on the components of the telehandler 10 that could cause its structural failure.

For example, the structural criticality condition is selected from the group consisting of:
structural criticality condition due to yielding of the lifting arm 50;
structural criticality condition due to buckling of the sections constituting the lifting arm 50;
structural criticality condition due to peak load of the actuators (operating the lifting arm 50 and/or stabilisers 22);
structural criticality condition for the load-bearing frame 20-tower 30 connection;
structural criticality condition for hydraulic circuit pressures (i.e. in the pump and/or actuators);
structural criticality condition due to breakage of the drive chains;
structural criticality condition due to breakage of the fifth wheel 40;
structural criticality condition for the strength of the support base (defined by stabilisers 22 and/or wheels 21); and
criticality condition for the strength of the connecting pivots (of the various moving components);
criticality condition for the mechanical strength of the telehandler frames.

In general, for (any) one structural criticality condition of the telehandler 10, the electronic control unit 810 is configured to determine a maximum stress value Sₘₐₓ as a maximum damaging/breaking strain Sfₘₐₓ of a component of the telehandler 10.

For example, the maximum strain Sfₘₐₓ can be a maximum bending moment, a maximum torsional moment or a maximum force depending on the component being stressed.

For example, the maximum damaging/breaking strain Sfₘₐₓ of the component can be obtained by the electronic control unit 810 from one or more of the aforesaid structural parameters.

The electronic control unit 810 is further configured to calculate the allowable stress value Sₐₘₘ (see block S1) in the current operating position as a corresponding allowable strain Sfₐₘₘ of said component of the telehandler 10 in the current operating position.

For example, the allowable strain Sfₐₘₘ can be a bending moment, a torsional moment or a force depending on the component being stressed.

Preferably, the allowable strain Sfₐₘₘ is calculated as the product of a determined (structural) safety factor FS and the maximum damaging/breaking strain Sfₘₐₓ in the current operating position.

The electronic control unit 810 is configured to calculate an allowable load value Q_{amm_3 . . . n}, under a respective structural criticality condition, based on the calculated allowable strain Sfₐₘₘ.

By way of non-limiting example, the calculation of an allowable load value Q_{amm_3} . . . Q_{amm_n} for a structural criticality condition for the breakage of the fifth wheel 40 is hereinafter described.

For example, in such a case, the electronic control unit 810 has available a maximum breaking moment MRmax of the fifth wheel 40 (i.e. the said maximum strain Sfₘₐₓ), which is retrieved by the storage unit 811 from the structural parameters of the telehandler 10.

The electronic control unit 810 is further configured to calculate an allowable breaking moment MRₐₘₘ (i.e. the so-called allowable strain Sfₐₘₘ) in the operating position as the product of the safety factor FS and the maximum breaking moment MRₘₐₓ in the current operating position.

The total stress, i.e. the total moment Mₜₒₜ, burdening on the fifth wheel 40 shall never exceed this allowable breaking moment MRₐₘₘ.

In general, the total moment Mₜₒₜ is given by two moment components, of which a vehicle moment Mᵥ due to the telehandler 10 own masses (in its current operating position), i.e. the sum of the moments developed by the masses of each component of the telehandler 10 that insists on the fifth wheel 40, and a moment of the lifted load M_{q} due to the load burdening on the equipment.

In practice, Mₜₒₜ=M_{q}+Mᵥ.

The electronic control unit 810 is then configured to determine the allowable moment of the lifted load M_{q_amm} as the moment such that the total moment Mₜₒₜ equals the allowable breaking moment MRₐₘₘ mentioned above.

To do this, the electronic control unit 810 determines the vehicle moment Mᵥ developed on the fifth wheel 40 from the masses of the components of the telehandler 10 (burdening on the fifth wheel itself), which is determined based on the aforesaid structural parameters and on the current operating position.

In particular, the vehicle moment Mᵥ is calculated based on the following formula:

$${M}_{v} = {Q}_{v} * {I}_{v} ,$$

where Qᵥ is the total mass of the components of the telehandler 10 burdening on the fifth wheel 40 (obtained by summing the masses of the components), e.g. calculated based on the structural parameters and the current operating position, and Iᵥ is the position of the projection onto said support area AP of the centre of gravity of the components of the telehandler 10 burdening on the fifth wheel 40), where Iᵥ is determined as a combination of structural parameters and the current operating position.

At this point, the electronic control unit 810 is configured to determine the allowable moment of the lifted load M_{q_amm} as the difference between the allowable breaking moment MRₐₘₘ and the calculated vehicle moment Mᵥ.

As the allowable moment of the lifted load M_{q_amm} is known, the electronic control unit 810 is configured to determine/calculate a third value of the allowable load Q_{amm_3} (in the current operating position and) for a structural criticality condition for the breakage of the fifth wheel 40, as the result of the fraction between the allowable moment of the lifted load M_{q_amm} and the position of the projection on the ground (or rather, on the support area AP) of the point of application I_{q} of the load on the equipment 55.

In practice, Q_{amm_3}=M_{q_amm}/I_{q}.

For example, the electronic control unit 810 is configured to calculate an allowable load value Q_{amm_4} . . . Q_{amm_n} for each structural criticality condition (listed above) of each component (resulting in a plurality of allowable load values for each current operating position).

For example, the allowable load value Q_{amm_4} . . . Q_{amm_n} is calculated, as described above, by determining a maximum damaging/breaking strain Sfₘₐₓ of a telehandler component 10, by calculating the allowable strain value Sfₐₘₘ of said component of the telehandler 10 in the present operating position as the product of a determined (structural) safety factor FS and the maximum damaging/breaking strain Sfₘₐₓ in the present operating position and, thereby, by calculating an allowable load value Q_{amm_4} Q_{amm_n}, in the respective structural criticality condition, based on the allowable strain Sfₐₘₘ calculated, e.g. by means of a certain own function (inverse of the function used for the structural calculation while designing the component of the telehandler 10).

Furthermore, it is not excluded that the solution to the calculation of the allowable load value Q_{amm_4} . . . Q_{amm_n} can be sought by the electronic control unit 810 by numerical means, for example by repeated convergent attempts (e.g. by applying the bisection method).

In addition, the electronic control unit 810 can be configured to determine (see block S2) a further estimated or limit allowable load value Q_{amm_n} at the current operating position, wherein said estimated or limit allowable load value Q_{amm_n} is determined as the output of a (single) pre-calibrated map, e.g., a single pre-calibrated map for a telehandler 10 wheel-supported condition and a single pre-calibrated (maximum structural load) map/table (and stored in the storage unit 811) for a condition supported on stabilisers 22, wherein each map is obtained for a given reference piece of equipment 55 and corrected with a conversion formula for the equipment currently connected to the lifting arm 50.

For example, the conversion formula is obtained by applying the Huygens-Steiner theorem, so as to create a transport moment that adapts the moment value which is in the table for the reference equipment to an equivalent moment value for the equipment 55 actually connected to the lifting arm 50 (and detected by the group of sensors 82).

Once the various allowable load values Q_{amm_1} . . . have been calculated/determined Q_{amm_n} (as output of blocks E1, E2, S1 and S2), as described above (for static/dynamic, equilibrium criticality conditions and for static criticality conditions), the electronic control unit 810 is configured to determine (a single value of) the maximum load Qₘₐₓ that can be lifted by the equipment 55 at the current operating position as the minimum of the aforesaid various calculated/determined allowable load values Q_{amm_1} . . . Q_{amm_n}.

It cannot be ruled out that the electronic control unit 810 may calculate only one allowable load value Qₐₘₘ, e.g. for a single criticality condition mentioned above, in which case the maximum load Qₘₐₓ that can be lifted by the equipment 55 in the current operating position will be assigned the said calculated allowable load value Qₐₘₘ.

At this point, as (for each current operating position of the telehandler 10) the maximum load value Qₘₐₓ that can be lifted by the equipment 55 is known, the electronic control unit 810 can be configured to activate a safety procedure (see block A1 of FIG. 5), if the equipment 55 in the current operating position is subjected to a (current) load, measured by means of the dedicated sensor, that exceeds the maximum load that can be lifted by the given equipment in the given current operating position.

For example, the safety procedure could provide to stop or limit (the operability of the lifting arm 50 and/or fifth wheel 40 of the) telehandler 10, for example by preventing/limiting further lifting of the load supported by the equipment 55 and/or repositioning the load to a reference (safe) position.

Alternatively or additionally, the safety procedure could provide activating one or more alarms perceivable to the user (such as a visual and/or audible and/or tactile alarm or similar, e.g. via the user interface 83.

At this point, as (for each operating position of the telehandler 10) the maximum load value Qₘₐₓ that can be lifted by the equipment 55 is known, the electronic control unit 810 can be configured to make available (see block A2 in FIG. 5) on a display of the telehandler 10, i.e. in the user interface 83, (and/or store in the storage unit 811) a map or diagram of calculated maximum loads Qₘₐₓ that can be lifted by the equipment 55 for any possible operating position of the telehandler 10 and any equipment 55 supported by the lifting arm 50.

For example, such a map or diagram can be obtained during an initialisation and/or testing step of the telehandler 10 and/or for each piece of equipment 55 that is connected to the lifting arm 50 (during the operating life of the telehandler 10).

The invention thus conceived is susceptible to several modifications and variations, all falling within the scope of the inventive concept.

Moreover, all details can be replaced by other technically equivalent elements.

In practice, the materials used, as well as the contingent shapes and sizes, can be whatever according to the requirements without for this reason departing from the scope of protection of the following claims.

1. A telehandler comprising at least one base frame, provided with ground support wheels and stabilisers, at least one telescopic lifting arm articulated to said base frame, at least one piece of work equipment supported by said lifting arm, and an electronic control unit configured to:
determine, by sensors, one or more position parameters indicative of a current operating position of the telehandler from among the possible operating positions of the telehandler;
calculate a maximum load that can be lifted by the equipment in the current operating position; and
activate a safety procedure, if the equipment in the current operating position is subjected to a load that exceeds the maximum load that can be lifted, wherein the maximum load that can be lifted by the equipment in the current operating position is calculated by the steps of:
determining an allowable load value for at least one criticality condition of the telehandler;
assigning to the maximum liftable load the allowable load value determined for said at least one criticality condition of the telehandler;
wherein determining the allowable load value for each criticality condition of the telehandler is carried out by a computation procedure comprising:
determining a safety factor for said criticality condition;
determining, for said criticality condition, a maximum stress value in the current operating position, based on the position parameters and/or predefined structural parameters of the telehandler;
calculating, for said criticality condition, an allowable stress value in the current operating position as the product of said safety factor by said maximum stress value in the current operating position; and
determining, for that criticality condition, the allowable load value as a function of that allowable stress value.

2. The telehandler according to claim 1, wherein the position parameters are selected from the group consisting of at least: lifting arm tilt, lifting arm extension, lifting arm angle, stabiliser position.

3. The telehandler according to claim 1, wherein the safety factor is a constant or a function of the position parameters in the telehandler current operating position and/or a parameter indicative of the equipment.

4. The telehandler according to claim 1, wherein the criticality condition is a structural equilibrium condition of the telehandler.

5. The telehandler according to claim 4, wherein, in determining the allowable load value for said structural equilibrium condition of the telehandler, the maximum stress value in the current operating position is a maximum overturning moment, and the allowable stress value in the current operating position is an allowable overturning moment, calculated as the product of the safety factor and the maximum overturning moment in the current operating position.

6. The telehandler according to claim 5, wherein said maximum overturning moment is equal to an allowable stabilising moment value in the current operating position, which can be calculated based on the position parameters and/or structural parameters of the telehandler.

7. The telehandler according to claim 5, wherein the value of a maximum over-turning moment in the current operating position is also determined based on one or more dynamic perturbation parameters, selected from the group consisting of: a parameter indicative of a predetermined air flow perturbing the structural equilibrium condition of the telehandler, a predetermined acceleration of one or more movable components of the telehandler, an acceleration of the telehandler when movable on the wheels, and a tilt of the base frame relative to the ground.

8. The telehandler according to claim 1, wherein the criticality condition is a structural criticality condition of the telehandler.

9. The telehandler according to claim 8, wherein, in determining the allowable load value for said structural criticality condition of the telehandler, the maximum stress value in the current operating position is a maximum damaging/breaking strain of a component of the telehandler in the current operating position, and the allowable stress value in the current operating position is an allowable strain of said component of the telehandler in the current operating position, calculated as the product of the safety factor and the maximum strain value in the current operating position.

10. The telehandler according to claim 9, wherein the electronic control unit is further configured to:
compare the calculated allowable load value for that structural criticality condition of the telehandler in the current operating position with a predetermined loading capacity; and
correct the allowable load value for said structural criticality condition of the telehandler in the telehandler current operating position by setting it equal to said loading capacity, if the calculated allowable load value is greater than the loading capacity.

11. The telehandler according to claim 10, wherein the loading capacity is determined as the output of a pre-calibrated map obtained for a given reference piece of equipment and corrected with a conversion formula for the piece of equipment currently connected to the lifting arm.

12. The telehandler according to claim 1, wherein the maximum load that can be lifted by the equipment in the current operating position is calculated by the steps of:
repeating the computation procedure for a plurality of different criticality conditions of the telehandler, e.g. for at least one equilibrium criticality condition and at least one structural criticality condition, so as to obtain a corresponding plurality of allowable load values;
assigning to the maximum load that can be lifted by the equipment in the current operating position the lowest of said allowable load values.

13. The telehandler according to claim 1, wherein the electronic control unit is further configured to make available on a telehandler display a map or diagram of maximum loads that can be lifted by the equipment calculated for any possible operating position of the telehandler and any piece of equipment supported by the lifting arm.

14. The telehandler according to claim 1, wherein the safety procedure provides to stop the telehandler and/or one or more of its movements.

15. The telehandler according to claim 1, wherein the equipment comprises at least one memory unit readable by a telehandler sensor, wherein the memory unit contains design and structural information/data of the equipment, the electronic control unit being configured to: read the memory unit by the sensor; retrieve design and structural information/data of the equipment currently connected to the lifting arm; and calculate the maximum load that can be lifted by the equipment in the current operating position based on said design and structural information/data of the equipment.

16. The telehandler according to claim 15, wherein the criticality condition is a structural equilibrium condition of the telehandler, wherein, in determining the allowable load value for said structural equilibrium condition of the telehandler, the maximum stress value in the current operating position is a maximum overturning moment, and the allowable stress value in the current operating position is an allowable overturning moment, calculated as the product of the safety factor and the maximum overturning moment in the current operating position, and wherein said maximum overturning moment is equal to an allowable stabilising moment value in the current operating position, which can be calculated based on the position parameters, the structural parameters of the telehandler, and the structural parameters of the equipment mounted on the lifting arm that have been retrieved from the memory unit of the equipment itself.

17. The telehandler according to claim 15, wherein the criticality condition is a structural criticality condition of the telehandler, wherein, in determining the allowable load value for said structural criticality condition of the telehandler, the maximum stress value in the current operating position is a maximum damaging/breaking strain of a component of the telehandler and/or the equipment in the current operating position, and the allowable stress value in the current operating position is an allowable strain of said component of the telehandler and/or the equipment in the current operating position, calculated as the product of the safety factor and the maximum strain value in the current operating position.
